(19) United States
(12) Patent Application Publication
(10) Pub. No.: US 2011/0011672 A1
(43) Pub. Date: Jan. 20, 2011

(54) Rope Ascending And Descending Equipment

(75) Inventor: John D. Price, JR., Baldwinsville, NY (US)

Correspondence Address: BOND, SCHOENECK & KING, PLLC, ONE LINCOLN CENTER, SYRACUSE, NY, 13202-1355, US

(73) Assignee: GOLFIRE, INC., Baldwinsville, NY (US)

(21) Appl. No.: 12/838,098

(22) Filed: Jul. 16, 2010

Related U.S. Application Data
(60) Provisional application No. 61/225,994, filed on Jul. 16, 2009.

(51) Int. Cl. A62B 1/16; A63B 29/02; A62B 35/00; A62B 1/14

(52) U.S. Cl. 182/5

(57) ABSTRACT

Rope equipment with a pivoting rope clamp including first and second members mechanically connected to each other so that they are free to rotate relative to each other and so that a rope can be secured to (for example, threaded through) the rope equipment. At some relative rotational position, or range of relative rotational positions, the first and second members will be sufficient spaced apart so that the equipment can slide relatively freely with respect to the rope. However, if the relative rotation position changes too much in either rotational direction (clockwise or counterclockwise), then the first and second members will clamp down on the rope and prevent it from sliding with respect to the rope equipment. Preferably, the first member is provided with friction braking holes to help constrain the rope to the rope equipment and also to provide some degree of friction braking on sliding motion between the rope and the rope equipment.

### RELATED APPLICATION

The present application claims priority to U.S. provisional patent application No. 61/225,994, filed on 16 Jul. 2009; all of the foregoing patent-related document(s) are hereby incorporated by reference herein in their respective entirety(ies).

### BACKGROUND OF THE INVENTION

1. Field of the Invention

The present invention relates to equipment for a person ascending and/or descending a rope (hereinafter called “rope equipment”) and more particularly to equipment for a firefighter ascending and/or descending a rope.

2. Description of the Related Art

FIGS. 1 to 4 show a prior art rope equipment 200 called PUMA PRO EN567 FUSION (note: the names PUMA PRO, EN567 and/or FUSION may be subject to trademark rights in the United States and/or various other jurisdictions throughout the world). Equipment 200 includes: pivoting member 201; and U-shaped member 202. Pivoting member 201 is free to rotate with respect to the U-shaped member in the R1 rotational direction (see FIGS. 3 and 4). More specifically, the pivoting member can rotate between the clamped (see DEFINITIONS section) position shown in FIG. 3 and the open position shown in FIG. 4. The pivoting connection between the pivoting member and the U-shaped member is rotationally biased so that equipment 200 is biased toward the clamped position of FIG. 3. As shown in FIGS. 3 and 4, rope 220 may be threaded through channel 208 (see FIG. 2) defined in U-shaped member 202. In the locked position, the rope is prevented from translating in the D1 direction with respect to equipment 200. In the open position, the rope is free to translate in the D1 direction. In this way a user can selectively choose, through equipment 200, to: (i) fix herself to a point on a rope; or (ii) slide freely along the rope in the D1 direction.

It is noted that the clamped position of equipment 200 clamps the rope by compressive clamping. This means that the opposing members of equipment 200 compress the rope directly between them, essentially compressing the rope in the radial direction of the rope.

FIGS. 5A, 5B and 6 show a prior art rope equipment 250 called STERLING ROPE-F4-DEMO (note: the name STERLING ROPE may be subject to trademark rights in the United States and/or various other jurisdictions throughout the world). Equipment 250 includes: pivoting member 251; and friction brake member 252. Equipment 250 is free to pivot between a first position (shown in FIG. 5A) and a second position (shown in FIG. 5B). Friction brake member 252 includes friction brake holes 262 and alignment hole 261. Pivoting member 251 includes alignment hole 263. As shown in FIG. 6, when the pivoting member is in the first position so that alignment holes 261, 263 are aligned, rope 253 can be threaded through the alignment holes and the friction brake holes and the so that the engagement between the rope and the friction brake member will allow the rope to slide with respect to equipment 250, but will serve to brake the sliding to some degree by friction. However, as the pivoting member is pivoted from the first position toward the second position, the alignment of the alignment holes begins to be lost and the rope begins to be pinched between the alignment holes in the pivoting member and the friction brake member. When the out-of-alignment condition and associated pinching forces become great enough, the rope can no longer slide through equipment 250, and equipment 250 will be fixed in the sliding direction with respect to the rope.

It is noted that the clamped position of equipment 250 clamps the rope by scissors-type clamping. This means that the opposing members of equipment 200 compress the rope at different locations along the axis of the rope to create shear forces which effectively fix, or clamp, the rope.

FIGS. 7 and 8 show rope equipment 300 which is called CMC Rescue Escape Artist (note: the name CMC RESCUE ESCAPE ARTIST may be subject to trademark rights in the United States and/or various jurisdictions throughout the world). This is another rope equipment that can be selectively fixed/free with respect to a threaded rope for use by firefighters and other climbers.

The following published documents may also include helpful background information: (i) US published patent application 2007/0000737 (“Bamberg”); (ii) U.S. Pat. No. 6,474,441 (“Bertolino”); (iii) US published patent application 2008/0245611; and (iv) US published patent application 2009/0120738.

Description of the Related Art Section Disclaimer: To the extent that specific publications are discussed above in this Description of the Related Art Section, these discussions should not be taken as an admission that the discussed publications (for example, published patents) are prior art for patent law purposes. For example, some or all of the discussed publications may not be sufficiently early in time, may not reflect subject matter developed early enough in time and/or may not be sufficiently enabling so as to amount to prior art for patent law purposes. To the extent that specific publications are discussed above in this Description of the Related Art Section, they are all hereby incorporated by reference into this document in their respective entirety(ies).

### BRIEF SUMMARY OF THE INVENTION

The present invention is directed to rope equipment with a pivoting rope clamp including first and second members mechanically connected to each other so that they are free to rotate relative to each other in a plane of rotation, wherein the first member defines a plurality of friction braking holes each respectively extending through the first member in a first direction. Preferably, the plane of rotation is at least substantially parallel to the first direction. Preferably, the first member is generally U-shaped with the arms of the “U” extending in the first direction and the plurality of friction braking holes being located at the bottom of the “U.” Preferably the second member is sized to fit between the arms of the “U.” Preferably, the second member includes a head portion having a head hole defined therein, with the head hole extending through the second member in a direction at least substantially perpendicular to the plane of rotation. Preferably, the second member defines a series of ridges sized and shaped to clamp a rope.

Various embodiments of the present invention may exhibit one or more of the following objects, features and/or advantages:

(i) rope equipment helpful in ascending a rope

(ii) rope equipment helpful in descending a rope; and

(iii) a rope equipment well suited to the work of firefighters.

According to one aspect of the present invention, a rope equipment for engaging with a rope used by a user in ascending and/or descending, includes: a first member, second member and a connection hardware set. The first member includes a handling portion. The second member includes a handling portion. The connection hardware set rotationally mechanically connects to the first member and the second member so that the first and second members are free to rotate relative to each other about a pivot axis between a first position, a second position and a third position. The first and second members are shaped, sized and rotationally connected so that the user can squeeze the handling portion of the first member and the handling portion of the second member towards each other to move the rope equipment from the first position, to and through the second position and further to the third position. The first and second members are further shaped, sized and rotationally mechanically connected to that they define a rope passage space through which the rope can be threaded and so that: (i) the rope is not substantially free to slide with respect to the rope passage space when the rope equipment is in the first position, (ii) the rope is substantially free to slide with respect to the rope passage space when the rope equipment is in the second position, and (iii) rope is not substantially free to slide with respect to the rope passage space when the rope equipment is in the second position.

According to a further aspect of the present invention, a rope equipment, for use with a rope, includes: a first member; a second member and a connection hardware set. The connection hardware set rotationally mechanically connects the first member and the second member so that the first and second members can rotate relative to each other about a pivot axis among and between a first position, a second position and a third position, with the second position being rotationally between the first position and the third position. The first member includes a first clamping portion and a second clamping portion. The second member includes a first clamping portion and a second clamping portion. The first member and second member are shaped, sized and/or mechanically connected so that when the equipment is in the first position and is being used with the rope, the first clamping portion of the first member and the first clamping portion of the second member will clamp the rope so that it is not free to slide with respect to the equipment. The first member and second member are shaped, sized and/or mechanically connected so that when the equipment is in the second position and is being used with the rope, the first clamping portion of the first member and the first clamping portion of the second member will not clamp the rope, and the second clamping portion of the first member and the second clamping portion of the second member will not clamp the rope, so that the rope is free to slide with respect to the equipment. The first member and second member are shaped, sized and/or mechanically connected so that when the equipment is in the third position and is being used with the rope, the second clamping portion of the first member and the second clamping portion of the second member will clamp the rope so that it is not free to slide with respect to the equipment.

According to a further aspect of the present invention, a rope equipment, for use with a rope, includes: a first member; a second member and a connection hardware set. The connection hardware set rotationally mechanically connects the first member and the second member so that the first and second members can rotate relative to each other about a pivot axis among and between a first position and a second position. The first member includes a first clamping portion. The second member includes a first clamping portion. The first member and second member are shaped, sized and/or mechanically connected so that when the equipment is in the first position and is being used with the rope, the first clamping portion of the first member and the first clamping portion of the second member will clamp the rope by compressive clamping so that it is not free to slide with respect to the equipment. The first member and second member are shaped, sized and/or mechanically connected so that when the equipment is in the second position and is being used with the rope, the first clamping portion of the first member and the first clamping portion of the second member will not clamp the rope so that the rope is free to slide with respect to the equipment. The first member includes a plurality of friction braking holes are at least substantially co-planar and define a friction braking hole plane.

### BRIEF DESCRIPTION OF THE DRAWINGS

The present invention will be more fully understood and appreciated by reading the following Detailed Description in conjunction with the accompanying drawings, in which:

FIG. 1 is an orthographic top view of a first prior art rope equipment;

FIG. 2 is an orthographic front view of the first prior art rope equipment;

FIG. 3 is an orthographic side view of the first prior art rope equipment;

FIG. 4 is another orthographic side view of the first prior art rope equipment;

FIG. 5A is an orthographic side view of a second prior art rope equipment;

FIG. 5B is another orthographic side view of the second prior art rope equipment;

FIG. 6 is another orthographic side view of the second prior art rope equipment;

FIG. 7 is an orthographic side view of a third prior art rope equipment;

FIG. 8 is an orthographic front view of the third prior art rope equipment;

FIG. 9 is an orthographic side view of a first embodiment of a rope equipment according to the present invention;

FIG. 10 is another orthographic side view of the first embodiment rope equipment;

FIG. 11 is another orthographic side view of the first embodiment rope equipment;

FIG. 12 is a perspective, generally rear, view of the first embodiment rope equipment;

FIG. 13 is an orthographic side view of a component of the first embodiment rope equipment;

FIG. 14 is an orthographic rear view of a component of the first embodiment rope equipment;

FIG. 15 is an orthographic side view of a component of the first embodiment rope equipment;

FIG. 16 is an orthographic top view of a component of the first embodiment rope equipment;

FIG. 17 is an orthographic side view of a component of the first embodiment rope equipment;

FIG. 18 is an orthographic rear view of a component of the first embodiment rope equipment;

FIG. 19 is an orthographic bottom view of a component of the first embodiment rope equipment;

FIG. 20 is an orthographic front view of a second embodiment of a rope equipment according to the present invention; and

FIG. 21 is an orthographic side view of the second embodiment rope equipment.

FIG. 22 is a perspective view of a third embodiment of a rope equipment according to the present invention

### DETAILED DESCRIPTION OF THE INVENTION

Discussion will being at a fairly general level with reference to rope equipment 500 shown in FIG. 22. Rope equipment 500 is an auto locking firefighter escape ascender/descender. Equipment 500 includes: protrusion 502; first friction braking hole (see DEFINITIONS section) 504; second friction braking hole 506; third friction braking hole 508; and rope 510. For clarity of illustration purposes: (i) only the central axis of rope 510 is shown in FIG. 22; and (ii) the rope is shown loosely threaded through equipment 500.

It is relatively low in cost for a rope equipment having its functionality. It is relatively small. For example, the embodiment of FIG. 22 is 1.5 inches wide by 5.5 inches long, and weighs approximately 7.4 ounces. Preferably, the equipment is made out of aluminum, and preferably grade 7075. Equipment 500 features an auto locking feature that adds security and enhances user confidence for a hands free exit of a building. It is built to allow for easy horizontal movement to the point of egress. In operation, the user's left hand controls the descent, while the users right hand releases the rope. If the user lets go of rope equipment 500, then the equipment will rotate into a position so that the rope cannot slide with respect to the rope equipment, and the user (who is connected to the rope equipment by a carabineer or the like) will stop. More specifically, the threading of the rope will control the relative mechanical orientation between the member equipment 500 having the friction braking holes and a taut rope 510. When in this relative mechanical orientation, downwards force on the carabineer hole (no reference number) in the other member will tend to rotate equipment 500 into a position that clamps the rope and prevents equipment 500 from sliding relative to the rope.

The low profile shape and size will fit in any bag and makes an advantageous addition to existing bailout systems. Equipment 500 can be used with rope (see DEFINITIONS section) or webbing. Instructions for using equipment 500 are provided at: http://www.gloveholders.com/ (and pages linked thereto, these documents are all fully incorporated by reference).

Preferably equipment 500 has no sharp edges. The edges of the holes 504, 506, 508 are preferably rounded or countersunk so that they do not have sharp edges. Hole 508 is preferably located close to the corner, but not so close that there is any significant possibility of cracking (even when taking into account any beveling and/or rounding of edges). In equipment 500, the member with only a single hole (that is, the carabineer hole) is shown with a nub (or protrusion 502). In some preferred embodiments of the present invention, protrusion 502 will be omitted.

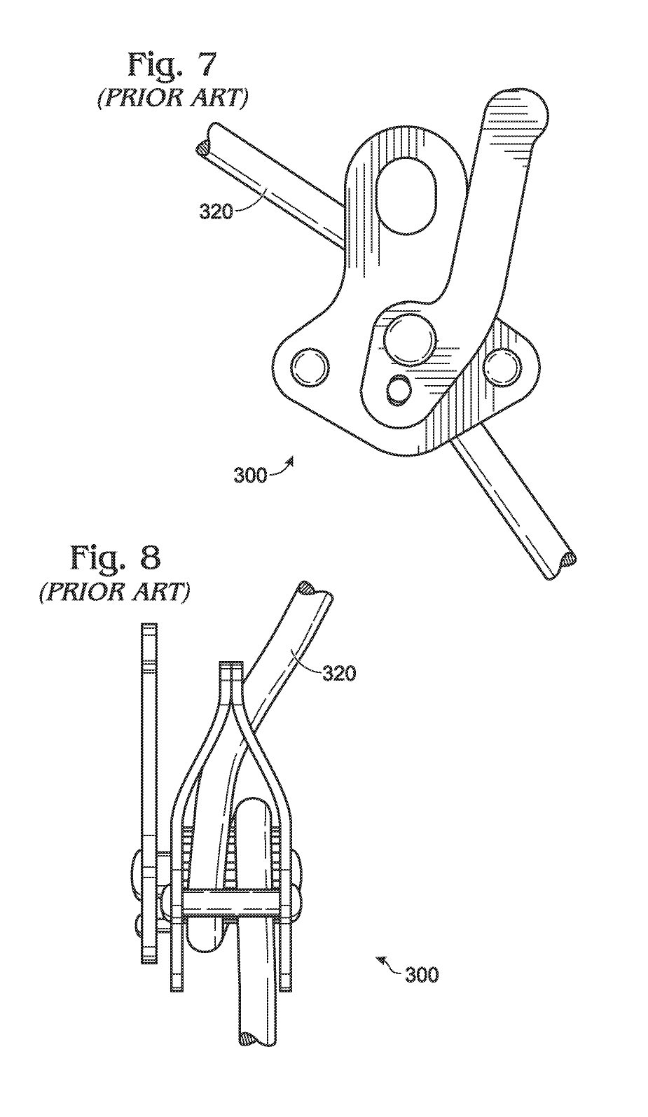

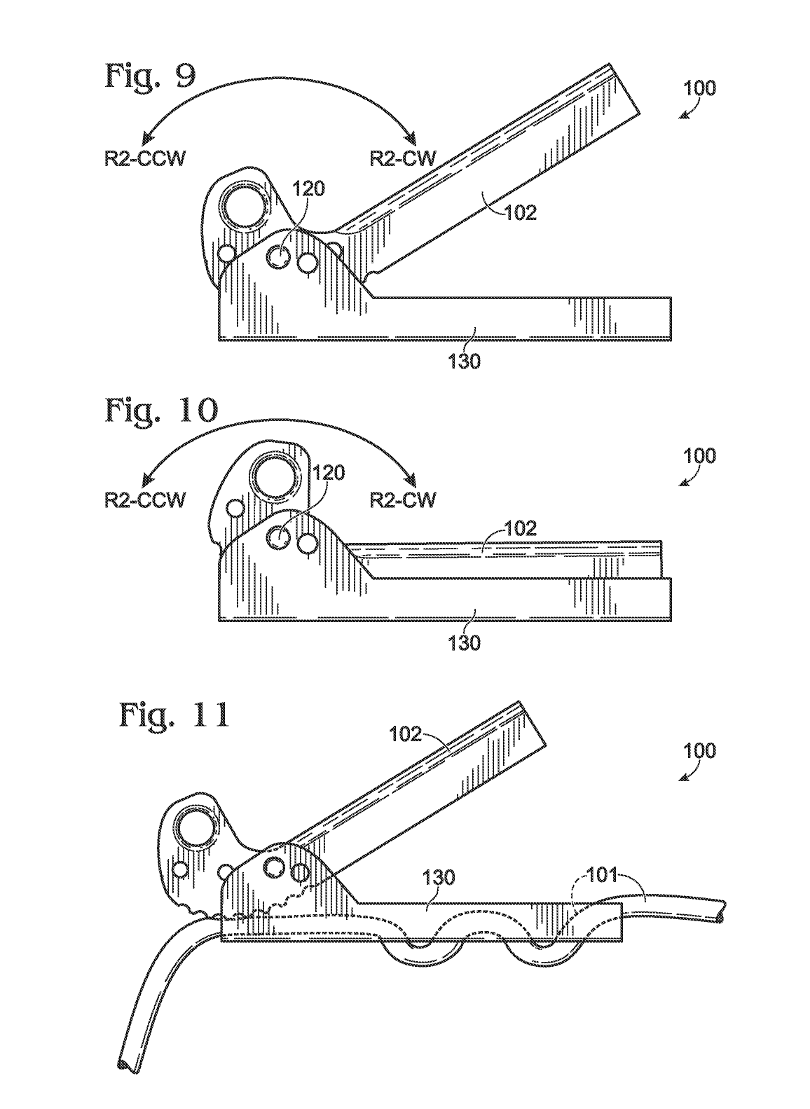

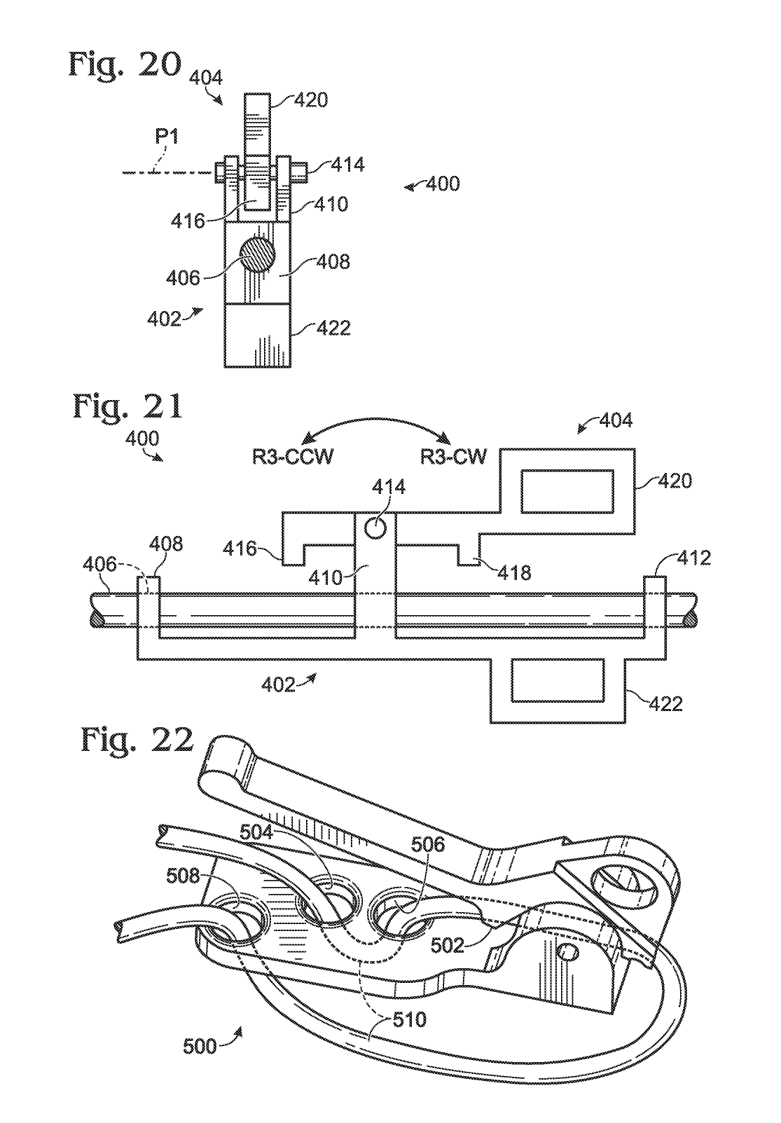

FIGS. 20 and 21 show rope equipment 400 according to the present invention, which is not necessarily preferred, but which: (i) is helpful in teaching some of the aspects of the present invention; and (ii) may help demonstrate the potential scope of the present invention (especially when it is contrasted with the preferred embodiment of FIGS. 9 to 19 which will be discussed below). Rope equipment 400 is used with rope 406 and includes: first member 402; second member 404; and connection hardware set 414. First member 402 includes first rope guide 408; connection hardware mount 410; and second rope guide 412; and finger grip 422. Second member 404 includes: first clamping protrusion 416; second clamping protrusion 418; and finger grip 420.

Connection hardware set 414 mechanically rotationally connects the first member to the second member so that the first and second members can rotate with respect to each other in the R3 direction about pivot axis P1. Connection hardware 414 includes a torsion spring to bias second member 404 to rotate in the R3-CCW direction with respect to the first member. Alternatively connection hardware could bias second member 404 to rotate in the R3-CW direction with respect to the first member. Alternatively, there could be no biasing of this relative rotation whatsoever.

The first and second members may rotate relative to each other among and between a first position, a second position and a third position. The second position is shown in FIG. 21. In this position, neither clamping protrusion 416, nor clamping protrusion 418, are pressed down against the rope. Because no portions of the second member are pressed down against it, the rope is free to slide when equipment 400 is in the second position.

When all hand pressure is released from finger grips 420, 422, then the bias provided by connection hardware 414 will cause the first and second members to rotate relative to each other so that second member 404 rotates in the R3-CCW direction relative to first member 402. This drives clamping protrusion 416 down to press against rope 406, thereby clamping the rope between clamping protrusion 416 and the body of first clamping member 402. This is the first position. The rope is not free to slide in the first position because of the clamping by clamping protrusion 416.

When the user squeezes together finger grips 420, 422, then the first and second members will rotate relative to each other so that second member 404 rotates in the R3-CW direction relative to first member 402. As equipment 400 rotates through the second position, the rope is free to slide, as explained above. However, as the user continues to squeeze the finger grips together, clamping protrusion 418 will move generally downwards to press against rope 406, thereby clamping the rope between clamping protrusion 418 and the body of first clamping member 402. This is the third position. The rope is not free to slide in the third position because of the clamping by clamping protrusion 418.

It is noted that both the clamped positions (that is, the first and third positions) of the rope are compressed by compressive clamping. In other words, the protrusion 416 (or 418) directly opposes the corresponding clamping surface of first member 402. Alternatively, equipment 400 could be modified so that one or both clamping positions worked by scissors-style clamping, or other types of clamping. For example, consider a variation on equipment 400 that includes alignable holes on the first and second members through which the rope passes. In this variation: (i) when the alignable holes are rotated into alignment then the equipment would be in the second position (free sliding); (ii) when the alignable holes were clockwise rotated out of alignment then the equipment would enter the first position where scissors-type clamping would occur (rope fixed); and (iii) when the alignable holes were counterclockwise rotated out of alignment then the equipment would enter the third position where scissors-type clamping would also occur (rope fixed). As a further example, consider a design with two sets of aligned holes with: (i) one set being out of alignment (and causing scissors-type clamping) when the equipment is rotated into the first position; and (ii) the other set being out of alignment (and causing scissors-type clamping) when the equipment is rotated into the third position.

It is further noted that the clamping of the first position of equipment 400 uses distinctly different portions of the first member and the second member to clamp than does the third position of equipment 400. More specifically: (i) the first position utilizes for clamping a leftwards portion of first member 402 and protrusion 416 of second member 404; and (ii) the third position utilizes for clamping a rightwards portion of first member 402 and protrusion 418 of second member 404. To put it another way, there are four distinct clamping surfaces, two on the first member and two on the second member.

FIGS. 9 to 19 show preferred embodiment rope equipment 100, for use with rope 101, the equipment including: clamping member 102; head hole 103; connecting hardware holes 104, 105, 106; clamping ridges 107; elongated portion 108; nose 109; connecting hardware 120; U-shaped member 130; connecting hardware receiving portion 131; friction brake portion 132; connecting hardware holes 133, 134; and friction braking holes 135, 136, 137, 138. To assemble equipment: (i) a selected set of connecting hardware holes 104, 105, 106 in the clamping member is moved into alignment with a selected set of connecting hardware holes 133, 134 in U-shaped member; (ii) connecting hardware 120 is then inserted through the aligned connecting hardware holes; and (iii) threads on connecting hardware 120 are threadably engaged with a nut (not shown) to form the pivoting connection between the clamping member and the U-shaped member.

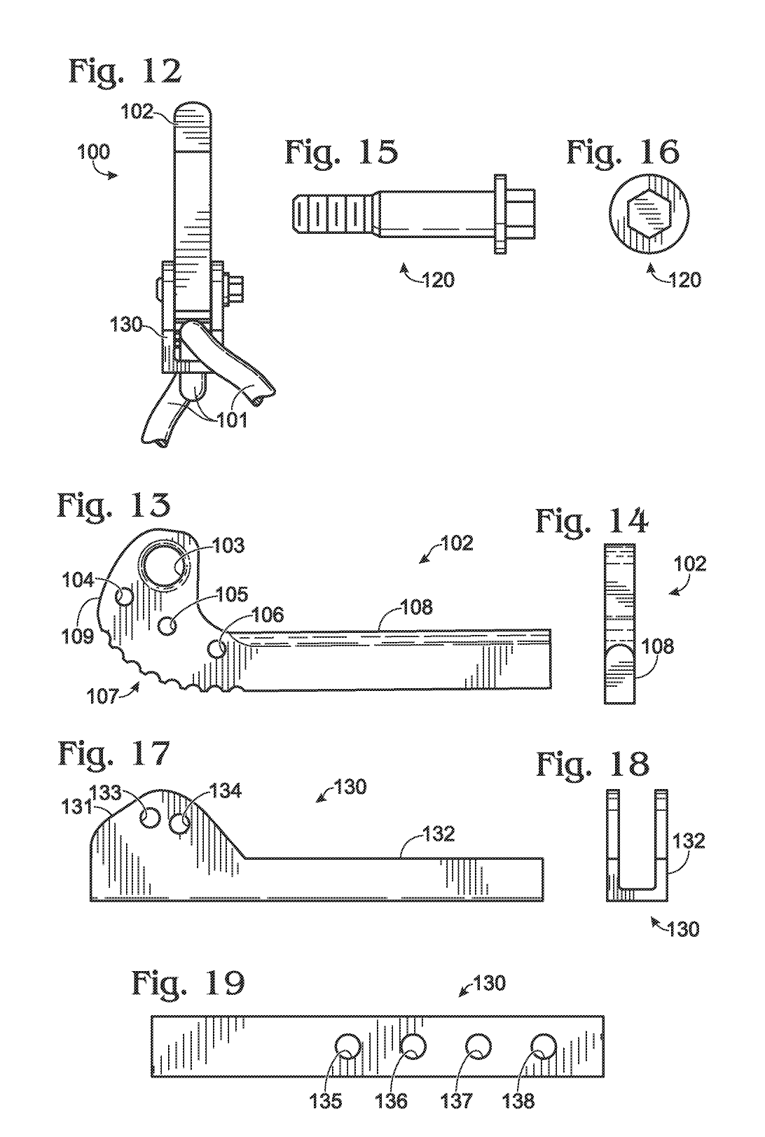

The pivoting connection allows the clamping member and the U-shaped member to rotate relative to each other, about the central axis of the connection hardware and in the rotational R2 direction (see FIGS. 9 and 10), between: (i) a first position (shown in FIG. 9); (ii) a second position (shown in FIGS. 11 and 12); and (iii) a third position (shown in FIG. 10). FIGS. 11 and 12 show how threaded rope 101 passes through the space between clamping member 102 and U-shaped member 130. When equipment 100 rotates into the first position, shown in FIG. 9, then clamping ridges 107 of clamping member 102 will clamp down on the portion of rope 101 that is threaded through the space between the clamping member and the U-shaped member, which means that the equipment cannot slide along the rope when the equipment is in the first position. When equipment 100 is rotated into the second (or intermediate) position, shown in FIGS. 11 and 12, then there will be sufficient space between the clamping member and the U-shaped member so that the equipment can slide freely relative to the rope when the equipment is in the second (or intermediate) position. When equipment 100 is rotated into the third position, shown in FIG. 10, then elongated portion of clamping member 102 will clamp down on the portions of rope 101 that are threaded within the interior space of the U-shape of the U-shaped member (FIG. 12 shows this part of rope 101), which means that the equipment cannot slide along the rope when the equipment is in the third position.

It will now be explained why the rope can slide in some angular positions of equipment 100, but not in others. In the first position, shown in FIG. 9, the clamping member has rotated in the R2-CCW direction with respect to the U-shaped member. This means that the clamping ridges 107 (see FIG. 13) of the clamping member, compressively clamps down on the rope and on the frontwards portion of the bottom of the “U” of the U-shaped member to fix the rope. In this position the clamping ridges press the rope against the bottom of the inside of the “U” of the U-shaped member at some point near the front of the equipment. This may be thought of as the frontwards clamping position. Depending upon the shapes of the U-shaped member and the clamping member and upon the location of the pivot axis, the clamping ridges, when in the frontwards clamping position, may clamp the rope in front of the pivot axis, directly under the pivot axis or perhaps even behind the pivot axis. Still, the clamping ridges are different from the part of the clamping member that is operative to clamp the rope in the third position.

In the third position, shown in FIG. 10, the clamping member has rotated in the R2-CW direction with respect to the U-shaped member as far as possible. This means that the elongated portion 108 (see FIG. 13) of the clamping member, clamps down on the portions of the rope threaded along the bottom of the interior space of the “U” of the U-shaped member. In this position the rope is squeezed between the against the bottom of the inside of the “U” of the elongated portion of the U-shaped member and the elongated portion of the clamping member. This may be thought of as the rearwards clamping position. In the third position, the rope is not free to slide.

The second position is a position, or perhaps more accurately a range of positions, between the frontwards clamping position and the rearwards clamping position. In the second position, the rope is free to slide because the clamping member, and especially clamping ridges 107 part of the clamping member is shaped so that there is good clearance between the clamping ridges and the bottom of the interior of the “U” of the U-shaped member when equipment 100 is in the second position(s). It is this second position clearance that permits the rope to slide so that a user can travel up and down the rope, secure in the knowledge that see will stop if equipment 100 is driven out of the second position(s) and into the first or third position.

In operation, equipment 100 works as will now be described. When a user's hand squeezes equipment 100 into the third position (see FIG. 10) then the equipment will be fixed relative to the rope, and when the user's hand unsqueezes slightly to allow the equipment to pivot into the second position (see FIGS. 11 and 12) then the equipment slides along the rope. What this means is that a user can quickly change between a sliding condition and a stationary condition by slightly squeezing and unsqueezing the equipment to adjust between the third and second positions as desired. This allows good control of ascending or descending operations because of the quickness and ease of changing between sliding and not-sliding. However, if the user let's go the rope equipment altogether, then the rope equipment will tend to pivot into the first position (see FIG. 9) where there is no sliding. this means that is some type of injury or distraction distracts the user into losing her grip on the rope equipment then she will not slide down the rope in an uncontrolled manner. This is a safety feature of the present invention, although a user may also take advantage of this feature intentionally (for example, to rest her hand, etc.). Besides safety, the hands free operation afforded by the present invention is potentially advantageous in many ways. For example, a firefighter may use her hands to exit or enter a window, secure in the knowledge that the rope equipment is fixed and will not let her slide down the rope. As another example, a rock climber may use his hands to find perches in the outcropping for gaining leverage to climb. As a another example, an oil rig repairman may use her free hand to work on pipes or the like.

As shown in FIGS. 11, 12 and 19, the rope is further threaded through the friction braking holes 135, 136, 137, 138. Preferably, a user will use equipment 100 with gloves to prevent rope burn on the hands. One advantage of these friction breaking holes is that their woven engagement with the U-shaped member helps ensure that the rope passes through the vicinity of the pivot axis (basically, the connection hardware) so that the direction of elongation of the rope is generally perpendicular to the direction of the pivot axis (see DEFINITIONS section). This is preferable. However, this perpendicular relationship is not necessarily required in all embodiments of the present invention. Also, this perpendicular relationship could be accomplished by different types of structures, such as by a loop at the distal end of the U-shaped member.

Alternatively, there could be more or fewer friction braking holes. Although not specifically shown on the drawings, bumps and/or ridges may be formed at the position where the holes meet the handle such that when the handle is squeezed, the bumps/ridges add friction to the rope for another option for a controlled descent. As a further option, the friction breaking holes could be located in the clamp member, rather than the U-shaped member so that the rope is threaded along the elongated portion of the clamping member, rather than that of the U-shaped member as shown in FIGS. 11 and 12. These kinds of friction-inducing structures (such as holes, bumps and/or ridges) are preferred, but may not be present in all embodiments of the present invention. It is also noted that even in the second (or intermediate) position, there will tend to be some friction between the clamping member and the rope, so that between this friction and the friction occasioned by any friction inducing structures, even when the equipment is free to slide, it will not be overly free to slide too easily, such that careful user control of ascents and/or descents is optimized.

It is noted that clamping member 102 is generally L-shaped so that head hole 103 is offset from the direction of elongation of the elongated portion (or handle portion) of clamping member 102. This is helpful because it means that equipment 100 will move into a clamping position (that is, the first or third position) when: (i) the U-shaped portion is threaded through a generally vertical rope (rope for ascending or descending); and (ii) a person's weight is attached to the head hole (for example, by means of a carabineer running through the head hole). In its preferred orientation, the U-shaped portion of equipment 100 is threaded through a vertical ascending/descending rope so that the elongated portions of members 102, 104 are pointing upwards, toward the sky. In this case, the weight of the person will pull on the head hole so that the clamping member rotates as far as it can in the R2-CCW direction (see FIG. 9) relative to the rope and the U-shaped member. As explained above, when equipment is rotated in this direction, it comes to occupy the first position, which is a clamping position. This means that if a person hanging from the head hole of equipment 100 entirely lets go of equipment 100, then equipment 100 will enter the first position automatically and the person will not slide down the rope and fall to the ground. This is the advantageous hands-free feature of certain embodiments of the present invention.

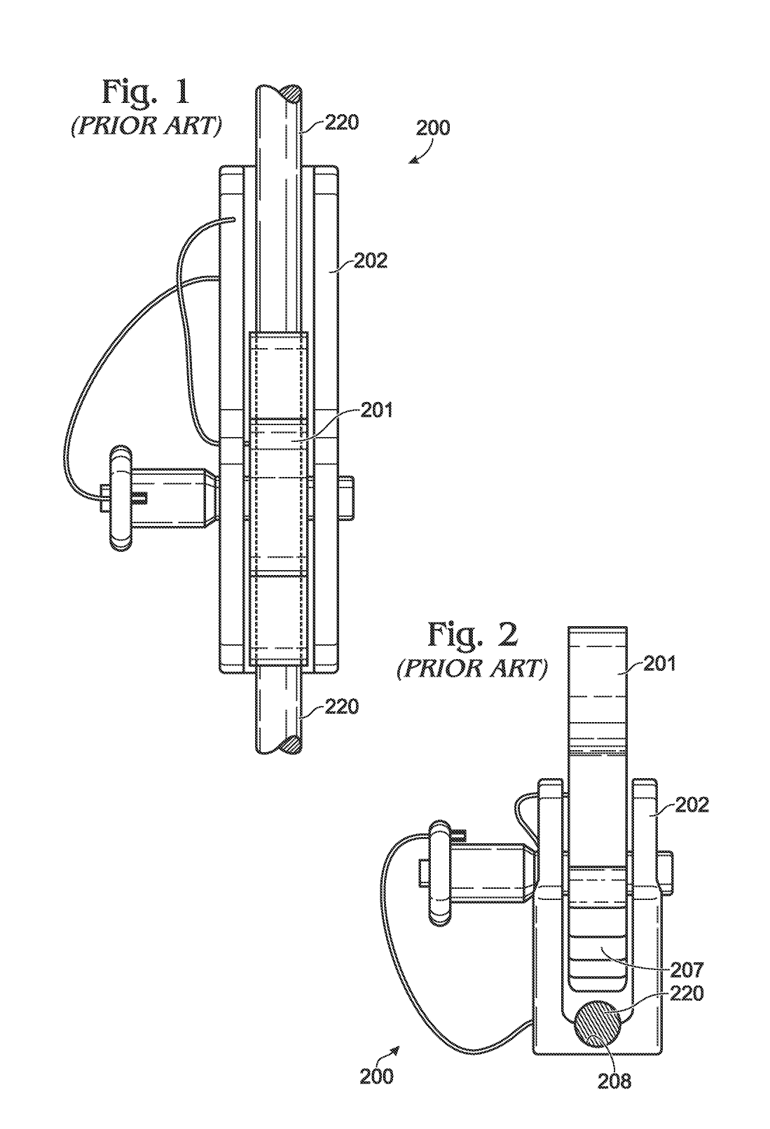

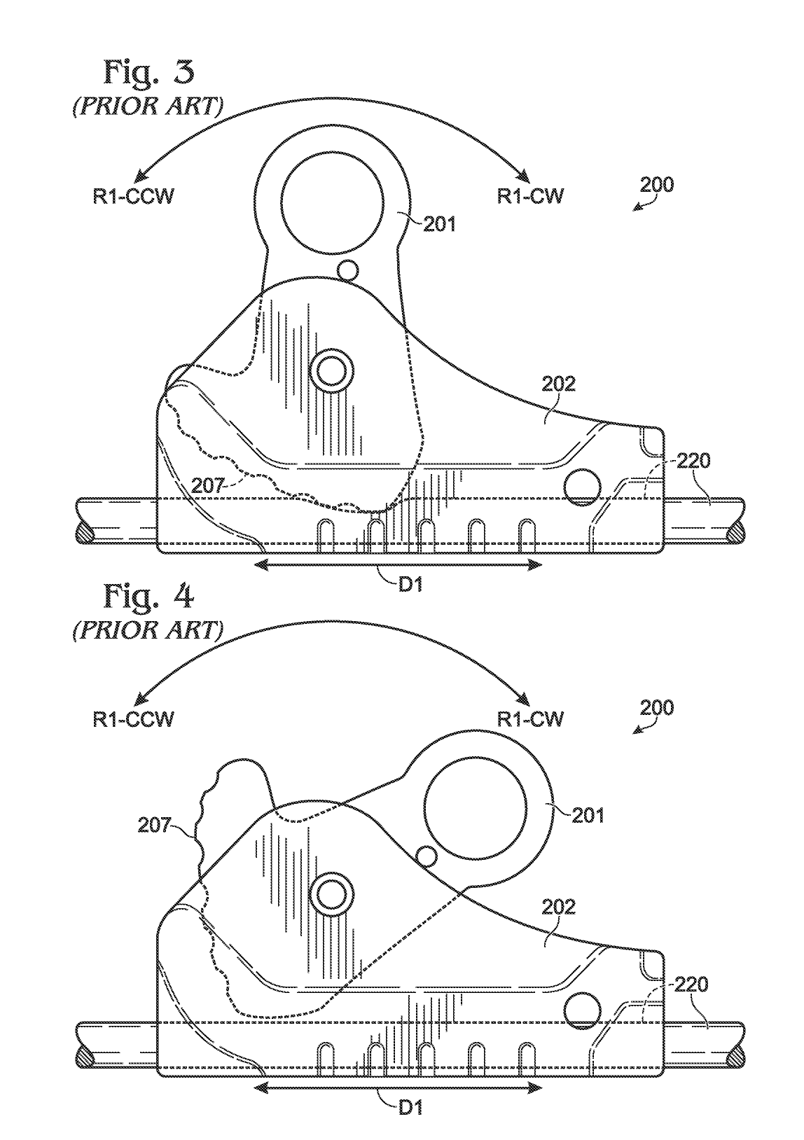

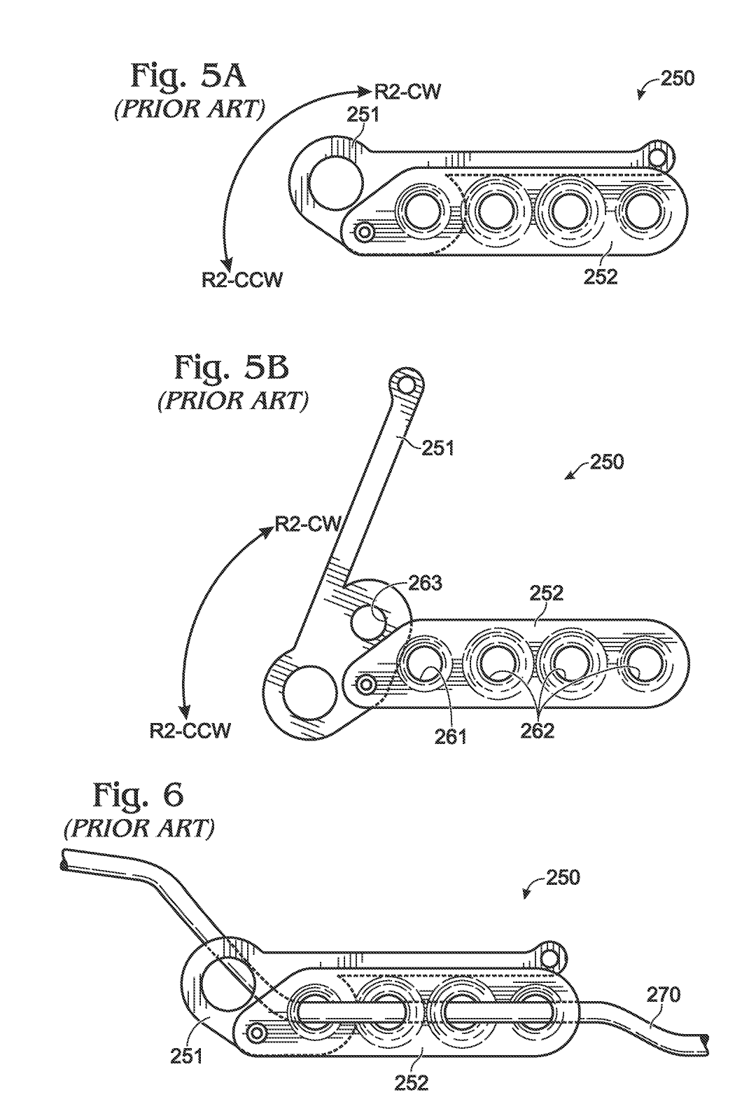

Another feature of equipment 100 (and equipment 500, discussed above in connection with FIG. 22) is that it combines the use of friction braking holes with compressive clamping. While the prior art equipment of FIGS. 1-4 compressively clamps the rope (when it is in the clamping position). However, this equipment has no friction braking holes. By having both compressive clamping and friction braking holes, the present invention forces the member with the friction braking holes to run in a generally vertical direction when a generally vertical, tensioned rope is threaded through the friction braking holes. Because the member with the friction braking holes remains generally vertical, this means the weight attached to the head hole will tend to rotate the equipment into a compressive clamping position, even when the user lets go of the equipment with her hands. This means that the equipment does not need to rotationally biased into its clamping position as the prior art of FIGS. 1-4 does. The combination of friction braking holes and compressive clamping allows hands-free operation without the expense of providing rotational bias hardware and without the attendant risk of failure of the rotational bias hardware.

One possible variation on the present invention is that the U-shaped member need not be U-shaped. Both the U-shaped member and the clamping member can have a wide variety of shapes so long as they have some type of portions that a user can squeeze to drive the pivoting motion between the two members.

Another possible variation on the present invention is that many types of connection hardware rotationally mechanically connect the clamping member and the U-shaped member. For example, the structures to make the rotational mechanical connection could be built into the clamping member and/or the U-shaped member itself in order to avoid the need for additional components in the connection hardware set. The mechanical rotational connection could be biased, such as rotationally biased outwards toward the third position as shown in FIG. 9. In some embodiments, the connection hardware could allow for some degree of relative translational motion between the U-shaped member and the clamping member, in addition to the relative rotation.

Rope equipment 100 includes multiple sets of holes to accommodate the connection hardware and define the pivot axis. This is preferred in embodiments where a single rope equipment will be used with different sizes of rope. In other embodiments, there may be only one rotational mechanical connection and it may be structured so that the major members are not easily detachably attachable as they are in rope equipment 100.

It is noted that the rope equipment of the present invention may also be used for travel along a rope in directions other than vertical, such as horizontal travel along a rope oriented in the horizontal direction.

### DEFINITIONS

Any and all published documents mentioned herein shall be considered to be incorporated by reference, in their respective entireties, herein to the fullest extent of the patent law. The following definitions are provided for claim construction purposes:

Present invention: means at least some embodiments of the present invention; references to various feature(s) of the “present invention” throughout this document do not mean that all claimed embodiments or methods include the referenced feature(s).

Embodiment: a machine, manufacture, system, method, process and/or composition that may (not must) meet the embodiment of a present, past or future patent claim based on this patent document; for example, an “embodiment” might not be covered by any claims filed with this patent document, but described as an “embodiment” to show the scope of the invention and indicate that it might (or might not) covered in a later arising claim (for example, an amended claim, a continuation application claim, a divisional application claim, a reissue application claim, a re-examination proceeding claim, an interference count); also, an embodiment that is indeed covered by claims filed with this patent document might cease to be covered by claim amendments made during prosecution.

First, second, third, etc. (“ordinals”): Unless otherwise noted, ordinals only serve to distinguish or identify (e.g., various members of a group); the mere use of ordinals shall not be taken to necessarily imply order (for example, time order, space order).

Mechanically connected: Includes both direct mechanical connections, and indirect mechanical connections made through intermediate components; includes rigid mechanical connections as well as mechanical connection that allows for relative motion between the mechanically connected components; includes, but is not limited, to welded connections, solder connections, connections by fasteners (for example, nails, bolts, screws, nuts, hook-and-loop fasteners, knots, rivets, quick-release connections, latches and/or magnetic connections), force fit connections, friction fit connections, connections secured by engagement caused by gravitational forces, pivoting or rotatable connections, and/or slidable mechanical connections.

Member: may be unitary or made up of multiple piece parts; may be rigid or at least somewhat flexible.

Rope: includes conventional rope, cables, lines and/or webbing.

Generally perpendicular to the pivot axis: as this term is used herein, a line, or member, or rope may be considered to be “generally perpendicular to the pivot axis” even if it is not perpendicular to it in the precise geometry sense of the word “perpendicular”; for example, as shown in FIG. 9, the elongated portion of U-shaped member 130 is offset from the pivot axis (that is, the central axis of connection hardware 120), but the direction of elongation of this elongated portion is still considered to be “generally perpendicular to the direction of the pivot axis” as that term is used in this document despite the offset; as shown in FIGS. 11 and 12, the portion of the rope in the vicinity of the pivot axis is considered to be “generally perpendicular to the pivot axis” even though: (i) the rope is offset from the pivot axis; and (ii) the rope is relatively flexible and may not be perfectly straight and/or parallel to a plane perpendicular to the pivot axis (even when considering the small portion of the rope “in proximity to the pivot axis” (see DEFINITIONS section)).

In proximity to the pivot axis: as shown in FIGS. 11 and 12, the portions of the rope that are not constrained by the rope equipment, at any given time, are free to bend rather sharply and arbitrarily; however, when a portion of a rope is described as being “in proximity to the pivot axis,” this is limited to the portion of the rope that is constrained to be in proximity to the pivot axis by the rope equipment itself, and not other portions of the rope that are unconstrained and which might cross the pivot axis by happenstance.

Elongation/direction of elongation: does not necessarily imply elongation in a linear direction; for example, and elongated member could be elongated along a curve and therefore have a curved direction of elongation.

Clamping: includes compressive clamping, scissors type clamping or any other type of clamping now known or to be developed in the future.

Friction braking hole: any hole defined within a member of a rope equipment through which a rope may be threaded or woven; the primary function (or even a substantial function) of a friction braking hole need not be friction, braking and/or braking by friction; indeed, in many embodiments of the present invention, an important function of these friction braking holes will be to provide and maintain a desired relative position and/or mechanical orientation between a rope equipment and a rope.

To the extent that the definitions provided above are consistent with ordinary, plain, and accustomed meanings (as generally shown by documents such as dictionaries and/or technical lexicons), the above definitions shall be considered supplemental in nature. To the extent that the definitions provided above are inconsistent with ordinary, plain, and accustomed meanings (as generally shown by documents such as dictionaries and/or technical lexicons), the above definitions shall control.

Unless otherwise explicitly provided in the claim language, steps in method steps or process claims need only be performed in the same time order as the order the steps are recited in the claim only to the extent that impossibility or extreme feasibility problems dictate that the recited step order be used. This broad interpretation with respect to step order is to be used regardless of whether the alternative time ordering(s) of the claimed steps is particularly mentioned or discussed in this document—in other words, any step order discussed in the above specification shall be considered as required by a method claim only if the step order is explicitly set forth in the words of the method claim itself. Also, if some time ordering is explicitly set forth in a method claim, the time ordering claim language shall not be taken as an implicit limitation on whether claimed steps are immediately consecutive in time, or as an implicit limitation against intervening steps.

What is claimed is:

1. A rope equipment for engaging with a rope used by a user in ascending and/or descending, the rope equipment comprising: a first member, second member and a connection hardware set, wherein:
the first member includes a handling portion;
the second member includes a handling portion;
the connection hardware set rotationally mechanically connects to the first member and the second member so that the first and second members are free to rotate relative to each other about a pivot axis between a first position, a second position and a third position;
the first and second members are shaped, sized and rotationally connected so that the user can squeeze the handling portion of the first member and the handling portion of the second member towards each other to move the rope equipment from the first position, to and through the second position and further to the third position; and
the first and second members are further shaped, sized and rotationally mechanically connected to that they define a rope passage space through which the rope can be threaded and so that: (i) the rope is not substantially free to slide with respect to the rope passage space when the rope equipment is in the first position, (ii) the rope is substantially free to slide with respect to the rope passage space when the rope equipment is in the second position, and (iii) rope is not substantially free to slide with respect to the rope passage space when the rope equipment is in the second position.

2. The equipment of claim 1 wherein:
the connection hardware set comprises:
at least one connection hardware hole defined in the first member,
at least one connection hardware hole defined in the second member, and
a connection hardware member at least substantially coaxial with the pivot axis; and
wherein the connection hardware member, the first member and the second member are sized, shaped, located and/or connected so that the connection hardware member passes through the at least one connection hardware hole defined in the first member and the at least one connection hardware hole defined in the second member.

3. The equipment of claim 1 wherein:
the handling portion of the first member is elongated in a direction generally perpendicular to the pivot axis; and
the handling portion of the first member is elongated in a direction generally perpendicular to the pivot axis.

4. The equipment of claim 1 wherein the handling portion of first member is generally U-shaped in cross-sections taken perpendicular its elongation direction.

5. The equipment of claim 4 wherein the handling portion of the second member is sized to fit at least partially between the arms of the U-shape of the handling portion of the first member as the rope equipment is rotated from the second position to the third position.

6. The equipment of claim 5 wherein:
the second member is generally L-shaped in a plane perpendicular to the pivot axis;
the pivot axis is located in proximity to the juncture between the two arms of the L-shape;
the handling portion of the second member is one arm of the L-shape; and
the second member further comprises a head portion that forms the other arm of the L-shape.

7. The equipment of claim 8 wherein:
the first member has a plurality of substantially co-planar friction braking holes defined therein;
the second member has a head hole defined therein, with head hole being suitable sized, shaped and/or located for attachment of a load to the equipment; and
the head hole is substantially offset from the plane of the substantially co-planar friction braking holes.

8. The equipment of claim 7 wherein:
the head hole defines a head hole central axis; and
the head hole central axis is at least substantially parallel to the plane of the friction braking holes.

9. A rope equipment, for use with a rope, the equipment comprising: a first member; a second member and a connection hardware set, wherein:
the connection hardware set rotationally mechanically connects the first member and the second member so that the first and second members can rotate relative to each other about a pivot axis among and between a first position, a second position and a third position, with the second position being rotationally between the first position and the third position;
the first member comprises a first clamping portion and a second clamping portion;
the second member comprises a first clamping portion and a second clamping portion;
the first member and second member are shaped, sized and/or mechanically connected so that when the equipment is in the first position and is being used with the rope, the first clamping portion of the first member and the first clamping portion of the second member will clamp the rope so that it is not free to slide with respect to the equipment;
the first member and second member are shaped, sized and/or mechanically connected so that when the equipment is in the second position and is being used with the rope, the first clamping portion of the first member and the first clamping portion of the second member will not clamp the rope, and the second clamping portion of the first member and the second clamping portion of the second member will not clamp the rope, so that the rope is free to slide with respect to the equipment; and
the first member and second member are shaped, sized and/or mechanically connected so that when the equipment is in the third position and is being used with the rope, the second clamping portion of the first member and the second clamping portion of the second member will clamp the rope so that it is not free to slide with respect to the equipment.

10. The equipment of claim 9 wherein:
the first member defines at least one alignment hole;
the second member defines at least one alignment hole;
the connection hardware set comprises a connection hardware member that passes through the at least one alignment hole in the first member and the at least one alignment hole in the second member and defines a central axis that is at least substantially aligned with the pivot axis.

11. The equipment of claim 9 wherein:
the first member comprises an elongated portion;
the second clamping portion of the first member is at least substantially located on the elongated portion of the first member;
the second member comprises an elongated portion; and
the second clamping portion of the first member is at least substantially located on the elongated portion of the first member.

12. The equipment of claim 11 wherein:
the second clamping member comprises a contoured surface that is contoured to help clamp the rope secured; and
the first clamping portion of the second member is located at least substantially on the contoured surface.

13. The equipment of claim 11 wherein the first member comprises a plurality of friction braking holes that are shaped, sized and/or located so that the rope can be woven through the friction braking holes to help constrain the rope to the first member.

14. The equipment of claim 13 wherein:
the plurality of friction braking holes are at least substantially co-planar and define a friction braking hole plane; and
the second member comprises a head hole that is substantially offset from the friction braking hole plane.

15. The equipment of claim 14 wherein:
the head hole defines a head hole central axis; and
the head hole central axis is at least substantially parallel to the plane of the friction braking holes.

16. The equipment of claim 10 wherein:
the first member comprises an elongated portion and a U-shaped portion;
the U-shaped portion of the first member has at least one alignment hole in each arm of the “U” shape so that the pivot axis runs transverse with respect to the arms of the “U” shape;
the elongated portion is generally flat; and
the second clamping surface of the first member is located where the U-shaped portion meets the elongated portion.

17. The equipment of claim 16 wherein:
the second member comprises an elongated portion, a first protrusion, a notched surface and a head portion;
the at least one alignment hole in the second member is located between the elongated portion and the head portion;
the first protrusion of the second member extends from the elongated portion of the second member;
the first protrusion of the second member forms the second clamping surface of the second member; and
the notched surface forms the first clamping surface of the second member.

18. The equipment of claim 9 wherein:
the first clamping surface of the first member is different than the second clamping portion of the first member; and
the first clamping surface of the second member is different than the second clamping portion of the second member.

19. A rope equipment, for use with a rope, the equipment comprising: a first member; a second member and a connection hardware set, wherein:
the connection hardware set rotationally mechanically connects the first member and the second member so that the first and second members can rotate relative to each other about a pivot axis among and between a first position and a second position;
the first member comprises a first clamping portion;
the second member comprises a first clamping portion;
the first member and second member are shaped, sized and/or mechanically connected so that when the equipment is in the first position and is being used with the rope, the first clamping portion of the first member and the first clamping portion of the second member will clamp the rope by compressive clamping so that it is not free to slide with respect to the equipment;
the first member and second member are shaped, sized and/or mechanically connected so that when the equipment is in the second position and is being used with the rope, the first clamping portion of the first member and the first clamping portion of the second member will not clamp the rope so that the rope is free to slide with respect to the equipment; and
the first member comprises a plurality of friction braking holes are at least substantially co-planar and define a friction braking hole plane.

20. The equipment of claim 19 wherein:
the second member comprises a head hole that is substantially offset from the friction braking hole plane;
the head hole defines a head hole central axis; and
the head hole central axis is at least substantially parallel to the plane of the friction braking holes.
